(19) United States
(12) Patent Application Publication
(10) Pub. No.: US 2011/0208505 A1
(43) Pub. Date: Aug. 25, 2011

(54) ASSIGNING FLOATING-POINT OPERATIONS TO A FLOATING-POINT UNIT AND AN ARITHMETIC LOGIC UNIT

(75) Inventors: David E. Mayhew, Northborough, MA (US); Mark D. Hummel, Franklin, MA (US)

(73) Assignee: ADVANCED MICRO DEVICES, INC., Sunnyvale, CA (US)

(21) Appl. No.: 12/711,710

(22) Filed: Feb. 24, 2010

(51) Int. Cl. G06F 9/302; G06F 1/32; G06F 9/455

(52) U.S. Cl. 703/26; 713/324; 712/222; 712/E09.017

(57) ABSTRACT

A processor may include a floating-point unit (FPU) and an arithmetic logic unit (ALU). Instructions to the processor may include greater or lesser amounts of floating-point operations and integer operations. In a circumstance where instructions include predominantly integer operations, power to the FPU may be reduced or turned completely off. In such a circumstance, occasional floating-point operations may be emulated and performed by the ALU. If the processor subsequently determines that incoming instructions include a greater proportion of floating-point operations, the FPU may be powered back on and used to perform the floating-point operations.

### TECHNICAL FIELD

The subject matter disclosed herein relates to assigning different types of operations to different circuits within a processor, for example, to assigning floating-point operations to a Floating Point Unit (FPU) and an arithmetic logic unit (ALU) in a processor.

### BACKGROUND

Many processor architectures include, among other components, an arithmetic logic unit (ALU) and a floating-point unit (FPU). An ALU is a digital circuit that carries out arithmetic and logic operations on integer (non-floating-point) numbers, and an FPU is a digital circuit that carries out operations on floating-point numbers. Instructions that are executed by a processor may include both integer operations and floating-point operations. In most circumstances, the processor uses an FPU to perform floating-point operations. However, the processor may also execute floating operations by emulating floating-point operations as integer operations and performing the emulated operations with an ALU.

In some circumstances, for example when a processor has only occasional floating-point operations to execute, it may reduce power consumption by turning off the FPU and using the ALU to emulate the occasional floating-point operations. Current technologies, however, do not include mechanisms for determining when to switch between using an FPU and using emulation for floating-point operations, or mechanisms for performing such a switch. Therefore, new approaches to assigning floating-point operations between an FPU and an ALU are required.

### SUMMARY

A method for use in a processor may include a first circuit performing operations of a first type and a second circuit performing operations of a second type. Based on the number of operations of the first type in a set of instructions, the processor may switch to use the second circuit to perform operations of the first type. Upon switching, the second circuit may be used by the processor to perform operations of the first type. The first circuit may be an FPU, and the operations of the first type may be floating-point operations. The second circuit may be an ALU, and the operations of the second type may be integer operations.

A processor may include a first circuit, a second circuit, and a switching control unit. The first circuit may be configured to perform operations of a first type, and the second circuit may be configured to perform operations of a second type. The switching control unit may be configured to switch the processor to use the second circuit to perform operations of the first type. The switching control unit may be configured to perform the switch based on a number of operations of the first type in a set of instructions. The processor may be configured, in response to the switch, to use the second circuit to perform operations of the first type. The first circuit may be an FPU and the operations of the first type may be floating-point operations. The second circuit may be an ALU, and the operations of the second type may be integer operations.

A computer-readable medium may store a set of instructions for execution by a processor. The set of instructions may include a first processing segment, a second processing segment, a switching control segment, and a third processing segment. According to the first processing segment, a first circuit performs operations of a first type. According to the second processing segment, a second circuit performs operations of a second type. According to the switching control segment, the processor may switch to using the second circuit to perform operations of the first type. The switch may be based on a number of operations of the first type in a set of instructions. According to the third processing segment, the processor may, in response to the switch, use the second circuit to perform operations of the first type. The first circuit may be an FPU and the operations of the first type may be floating-point operations. The second circuit may be an ALU, and the operations of the second type may be integer operations.

### BRIEF DESCRIPTION OF THE DRAWINGS

A more detailed understanding may be had from the following description, given by way of example in conjunction with the accompanying drawings wherein:

FIG. 1 shows an example method for assigning floating-point-operations between an FPU and an ALU in a processor;

FIG. 2 is a block diagram of a processor that is configurable to assign floating-point-operations between an FPU and an ALU; and

FIG. 3 shows example assignments of floating-point operations between an FPU and an ALU.

### DETAILED DESCRIPTION

Described in detail hereafter are methods, apparatus, and computer-readable media for assigning floating-point operations between an FPU and an ALU. A set of processor-executable instructions may be categorized based on how many floating-point operations (or the percentage of floating-point operations) are included in the set. The set of instructions may be made up, for example, of predominately floating-point operations, of predominately integer operations, or of a combination of floating-point and integer operations. In a circumstance where instructions include predominantly integer operations, power to the FPU may be reduced or turned completely off. If the FPU power is decreased or turned off, occasional floating-point operations may be emulated and performed by the ALU. If a later set of instructions includes a greater proportion of floating-point operations, power may be increased or turned back on at the FPU and the FPU may be used to perform the floating-point operations. By switching between using the FPU or using the ALU/emulation when appropriate, processor power consumption may be decreased without noticeably affecting processor performance.

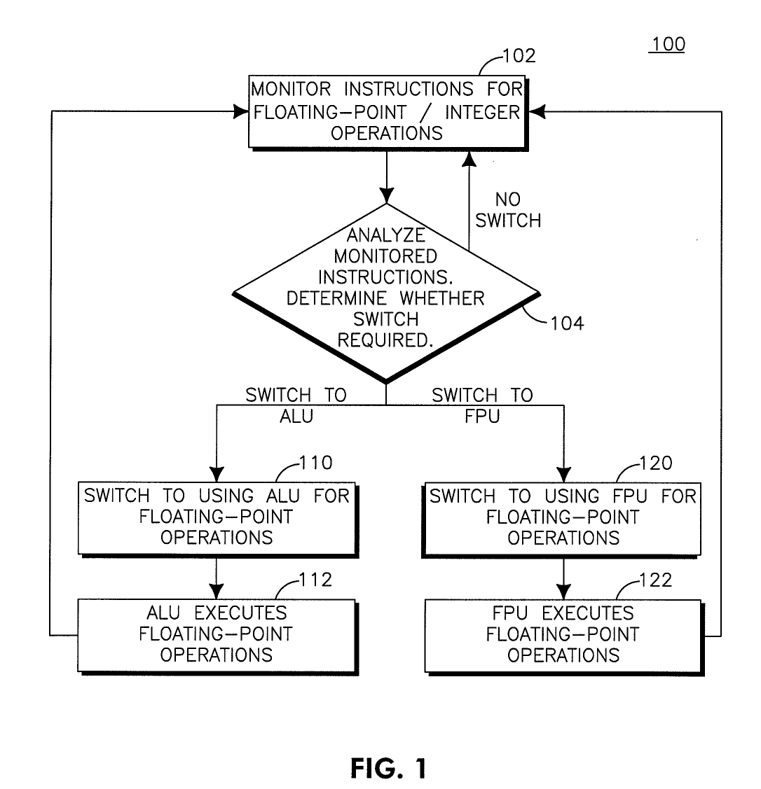

FIG. 1 shows an example method 100 for assigning floating-point-operations between an FPU and an ALU in a processor. The processor monitors instructions to determine whether they contain floating-point and/or integer operations (step 102). The monitoring may be based on the number of floating point operations and/or integer operations included in the instructions. For example, monitoring may include incrementing a counter that indicates how many floating-point operations are included in the set of instructions. Alternatively or additionally, monitoring may include maintaining one or more variables that indicate the frequency of floating-point operations in the set of instructions (i.e., how many floating point operations are included for a given period of time). Alternatively or additionally, the monitoring may include maintaining a variable that indicates a ratio of floating-point operations to integer operations for a given number of operations. As an example, a ratio of floating-point operations to integer operations may be maintained for the most recent one hundred instructions (or some other amount of instructions).

The processor analyzes the monitored instructions, and makes a determination as to whether a switch is required so that floating-point operations are executed by the FPU or by the ALU using emulation (step 104). This determination may be made by comparing the monitored instructions to a threshold.

As an example, if a ratio of floating-point operations to integer operations is maintained, the ratio may be compared to a threshold. The processor may then determine that, if, for example, less than ten percent (or some other proportion) of recent instructions include floating-point operations, then floating-point operations should be emulated and executed by the ALU.

The determination may further be based on the current state of the processor. For example, if conditions indicate that floating-point operations should be executed by the ALU and the ALU is already being used to execute floating-point operations, then no change is required. On the other hand, if conditions indicate that floating-point operations should be executed by the ALU but the FPU is being used to execute floating-point instructions, then a switch should be made to using the ALU to execute emulated floating-point operations. Thresholds that are used to make this determination may be hard-coded and/or may be configured at runtime. For example, a processor running on a computing device that is capable of running on both battery and AC power may be configured to use different threshold values when using battery or AC power. The processor may be configured to require a higher ratio of floating-point operations to use the FPU when running on battery power, and require a lower ratio of floating-point operations to use the FPU when running on AC power.

If the processor determines that no switch is required (step 104), the processor returns to monitoring instructions (step 102).

If the processor determines that a switch to using the ALU for floating-point operations should be made (step 104), the processor switches to using the ALU for floating-point operations (step 110). This switch may include, for example, the current state of the FPU being retrieved and loaded into an emulation unit. State information that may be retrieved and loaded may include data related to register contents and condition codes.

The switch to using the ALU for floating-point operations (step 110) may additionally include adjusting how power is provided to the FPU. For example, the switch may include clock gating the FPU. According to normal operation, a clock signal (a control signal which is used to define a time reference within the processor) is transmitted from a common point to every element in the processor that requires the clock signal. The clock signal may be transmitted along a network of elements in the processor, wherein the network is arranged in a tree structure (the “clock tree”). Clock gating a given node in the clock tree results in the clock signal not being sent to any descendent nodes of the given node. The FPU's portion of the clock tree may be clock gated, such that the FPU does not receive the clock signal. By clock gating the FPU, a portion of the FPU may be disabled to reduce its power consumption. In various implementations, fine-grained clock gating or course grained clock gating may be used. With fine-grained clock gating, either the FPU itself or a node close to the FPU is clock gated. With course-grained clock gating, a node in the clock tree further away from the FPU and closer to the source of the clock signal is gated.

In addition to or as an alternative to clock gating, the processor may also establish power gating as part of the switch (step 110). With power gating, a regulator in the processor shuts down power to one or more particular components of the processor. Using power gating, the processor may shut down power to the FPU. Power gating may be used in circumstances which include, but are not limited to, circumstances wherein the FPU is implemented on its own power island in the processor.

After the switch is performed, the floating-point operations are emulated by the emulation unit and performed by the ALU (step 112). The emulation unit may emulate the floating-point instructions by directly invoking a set of microcode instructions that obtain the same result as the floating-point operations but include only integer operations (and may therefore be performed by the ALU). Invoking the set of microcode instructions may include loading the microcode instructions into a control store in the processor. Alternatively or additionally, the emulation unit may emulate the floating-point instructions by invoking a software module that emulates the floating-point operations. Emulation of the floating-point instructions by the software module may ultimately result in the execution of microcode instructions by the processor; however, when a software module is used, the emulation unit need not (though may) directly load the microcode instructions into the control store and/or directly invoke the microcode instructions. Like the microcode instructions directly invoked by the emulation unit, microcode instructions invoked by the software module obtain the same result as the floating-point operations but include only integer operations.

If the processor determines that a switch to using the FPU for floating-point operations should be made (step 104), the processor switches to using the FPU for floating-point operations (step 120). The switch may include, for example, retrieving the state of an emulation unit that was emulating floating-point operations and loading the state into the FPU. State information that may be retrieved and loaded may include data related to register contents and condition codes. In an instance where power gating, clock gating, and/or any other power-reduction operations were performed with respect to the FPU, the power-reduction operations may be undone, such that the FPU receives power according to normal operation. After the switch is performed, the floating-point operations are executed by the FPU (step 122).

After or during execution of the floating-point operations, whether performed by using the FPU (step 122) or by using the ALU (step 112), the processor monitors instructions as described above (step 102).

In various implementations, any combination of the steps 102, 104, 110, 112, 120, 122 and/or sub-elements of the steps 102, 104, 110, 112, 120, 122 described above with reference to FIG. 1 may be performed. The steps 102, 104, 110, 112, 120, 122 and/or sub-elements of the steps 102, 104, 110, 112, 120, 122 may be performed in any order, including concurrently. As an example, the processor may monitor instructions (step 102) and/or determine whether a switch is required (step 104), while executing floating-point operations using emulation and an ALU (step 112). Alternatively or additionally, the processor may monitor instructions (step 102) and/or determine whether a switch is required (step 104), while executing floating-point operations using an FPU (step 122).

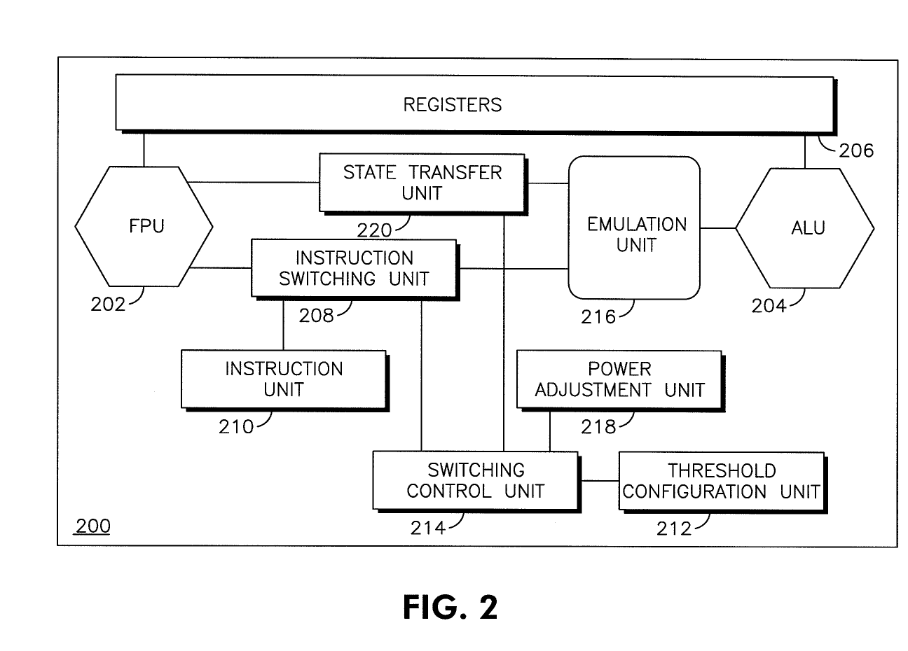

FIG. 2 is a block diagram of a processor 200 that is configurable to assign floating-point operations between an FPU 202 and an ALU 204. The processor 200 includes registers 206, which may be configured to store data and which may be accessed by the FPU 202 and/or the ALU 204. The registers 206 may be implemented as one or more Random-Access Memory (RAM) devices such as Dynamic RAMs (D-RAM) or Static RAMs (S-RAMs), or other type of memory devices or other computer-readable media. The processor 200 includes an instruction unit 210, which may be configured to fetch and/or decode instructions to be executed by the processor 200. The registers 206 may be used the processor 200 to store data related to the operations performed by the FPU 202 and/or the ALU 204.

The switching control unit 214 may be configured to monitor instructions at the instruction unit 210 to determine whether the instructions contain floating-point and/or integer operations. The switching control unit 214 may monitor instructions as described above with reference to step 102 of FIG. 1. The switching control unit 214 may additionally be configured to determine whether a switch in the processor 200 should be made, such that floating-point operations are executed by the FPU 202 or by the ALU 204 using emulation. The switching control unit 214 may make this determination as described above with reference to step 104 of FIG. 1.

If the switching control unit 214 determines that a switch to using the ALU 204 for floating-point operations should be made, the processor 200 may modify its operating state such that the emulation unit 216, in conjunction with the ALU 204, emulates and executes floating-point operations. This switch may include loading the FPU 202 state into the emulation unit 216, which may be performed by and/or managed by the state transfer unit 220. This switch may also involve adjusting how power is provided to the FPU 202, which may be performed by the power adjustment unit 218. The power adjustment unit 218 may adjust how power is provided to the FPU 202 as described above with reference to step 110 of FIG. 1. While the emulation unit 216 and ALU 204 execute floating-point operations, the instruction switching unit 208 provides the appropriate instructions to the emulation unit 216 and ensures that the instructions do not go to the FPU 202. The emulation unit 216, in conjunction with the ALU 204, may emulate floating-point operations as described above with reference to step 112 of FIG. 1.

If the emulation unit 216 invokes a software module (not depicted) to emulate floating-point operations, the software module may be stored in a memory (not depicted) accessible to the processor 200. The emulation unit 216 may, for example, call one or more functions in the software module to emulate the floating-point operations. The software module may emulate the floating-point operations and store the emulation result in a register in the registers 206. Alternatively or additionally, the emulation unit 216 may directly invoke one or more microcode instructions to emulate the floating-point operations. The microcode instructions may be loaded into a control store (not depicted) in the processor 200.

If the switching control unit 214 determines that a switch to using the FPU 202 for floating-point operations should be made, the processor 200 may modify its operating state such that the FPU 202 executes floating-point operations. This switch may include loading the state of the emulation unit 216 into the FPU 202, which may be performed by and/or managed by the state transfer unit 220. This switch may also involve adjusting how power is provided to the FPU 202, which may be performed by the power adjustment unit 218. The power adjustment unit 218 may adjust how power is provided to the FPU 202 as described above with reference to step 120 of FIG. 1. While the FPU 202 executes floating-point operations, the instruction switching unit 208 provides the appropriate instructions to the FPU 202 and ensures that the instructions do not go to the emulation unit 216.

Each of the units 202, 204, 208, 208, 210, 212, 214, 216, 218 of the processor 200 may be implemented as a circuit, a software module, or a firmware module. Alternatively or additionally, any combination or sub-combination of the units 202, 204, 208, 208, 210, 212, 214, 216, 218 may be implemented across any combination of circuits, software modules, and/or firmware modules.

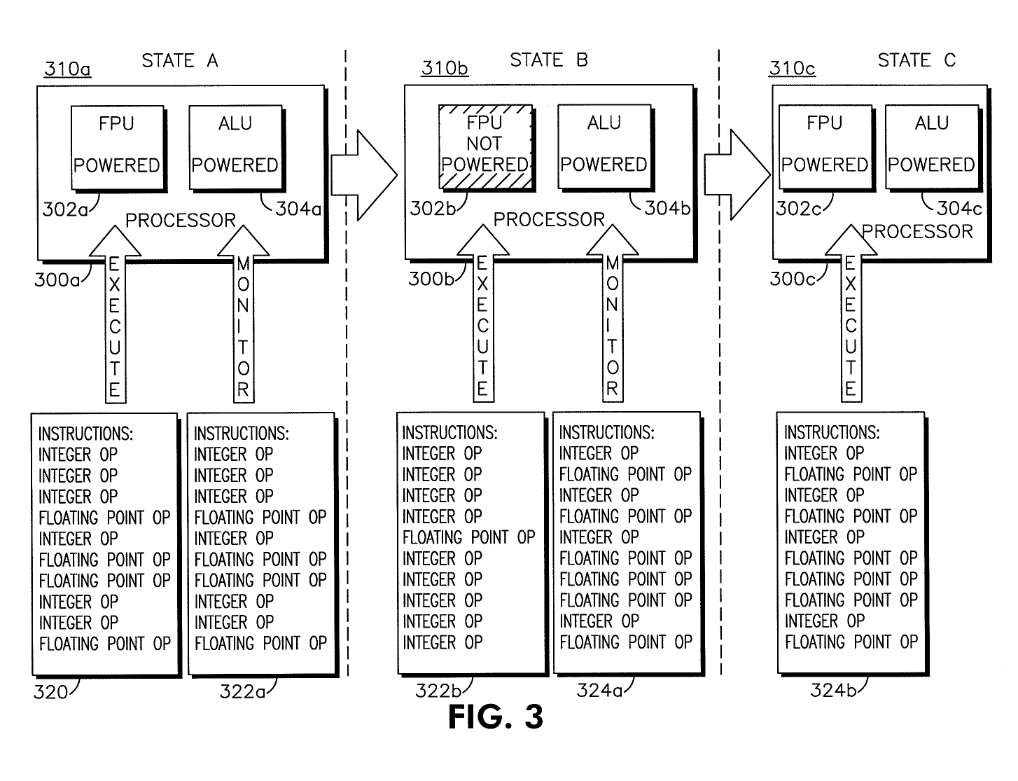

FIG. 3 shows an example of how floating-point operations may be assigned to an FPU 302a, 302b, 302c and an ALU 304a, 304b, 304c in a processor 300a, 300b, 300c.

At State A 310a, the processor 300a executes a first set of instructions 320, which includes a mixture of integer and floating-point operations. At State A 310a, both the ALU 304a and FPU 302a receive power, and the processor 300a uses the ALU 304a to perform the integer operations in the first set of instructions 320 and uses the FPU 302a to perform floating-point operations in the first set of instructions 320. While executing the first set of instructions 320, the processor 300a monitors a second set of instructions 322a, which sequentially follows the first set of instructions 320. The second set of instructions 322a includes predominantly integer operations. Based on the scarcity of floating-point operations in the second set of instructions 322a, the processor 300a makes a determination to transition to State B 310b.

At State B 310b, the processor 300b has finished executing the first set of instructions 320. The processor 300b has powered off the FPU 302b, but the ALU 304b remains powered on. The processor 300b uses the ALU 304b to perform the integer operations included in the second set of instructions 322a. The processor 310b also uses the ALU 304b, in conjunction with floating-point emulation, to perform the single floating-point operation in the second set of instructions 322a. While executing the second set of instructions 322a, the processor 300b monitors a third set of instructions 324a, which sequentially follows the second set of instructions 322a. The third set of instructions 324a includes a mixture of floating-point operations and integer operations. Based on the number and/or ratio of floating-point operations in the third set of instructions 324a, the processor 300b makes a determination to transition to State C 310c.

At State C 310c, the processor 300c has finished executing the second set of instructions 322a. The processor 300c has powered the FPU 302c back on. The processor 300c uses the ALU 304c to perform the integer operations included in the third set of instructions 324b, and the processor 300c uses the FPU 302c to perform the floating-point operations indicated in the third set of instructions 324b. At State C 310c, the processor 300c may monitor additional instructions (not depicted) and may make additional determinations to transition or not transition to further additional states based on the additional instructions.

Although features and elements are described above with reference to FIGS. 1-3 in terms of assigning instructions between an ALU and an FPU, the above-described principles are equally applicable to other contexts involving different types of processors, circuits, and types of operations. For example, instructions may be analyzed to determine to what extent they contain graphics operations or non-graphics operations, and performance of the operations may be assigned to a GPU or a general-purpose processor. A software module in an operating system, for example, may monitor instructions for whether they include graphics operations or non-graphics operations, and assign the operations accordingly. Alternatively or additionally, a single circuit may include components designed specifically for graphics operations (such as, but not limited to, a GPU) and include components designed for non-graphics operations (such as, but not limited to, a processor, an ALU, an FPU, or other type of circuit). The single circuit may monitor instructions for whether they include graphics operations or non-graphics operations, and assign the operations accordingly. These principles may similarly be applied to instructions that include, for example, Streaming Single Instruction, Multiple Data (SIMD) Extensions (SSE) operations or Matrix Math Extensions (MMX) operations.

Further, the above-described principles may be applied, mutatis mutandis, to contexts that involve more than two types of operations. For example, a processor, using the principles described above, may assign three different types of operations between three different types of circuits.

Although features and elements are described above in terms of assigning instructions based on the contents of instructions, the assignment of instructions may alternatively or additionally be based on parameters related to thermal conditions. For example, if a temperature above a threshold is reached, a determination may be made to switch to assign instructions to a different circuit, when doing so gives off less heat. This principle may be applied, for example, in a processor wherein less heat is generated when an ALU is used to emulate floating-point operations.

The assignment of instructions may alternatively or additionally be based on parameters related to power conditions. For example, when a power usage threshold is reached, a determination may be made to switch to assign instructions to a different circuit, when doing so uses less power. This principle may be applied, for example, in a processor wherein less power is used when an ALU is used to emulate floating-point operations. When a processor includes an integrated GPU, floating-point emulation may be used to allow more power to be allocated to the GPU.

Further, in a processor that includes a hypervisor, instructions may be assigned based on which guest operating system is requesting execution of the instructions. In a processor that includes a hypervisor, the processor may run multiple guest operating systems. The hypervisor controls how processor resources are allocated to the different guest operating systems (OSs). The hypervisor may be implemented as, for example, a firmware module, software module, or combination thereof. The hypervisor may assign instructions on a per-OS basis, such that the floating-point instructions associated with one or more OSs are executed using ALU-based emulation. In a processor with multiple cores, the hypervisor may turn off the FPU and use ALU-based emulation in one or more of the cores, and the hypervisor may assign the one or more OSs to the cores with the turned-off FPUs. Assignment of guest OSs to using emulated floating-point operations may be based on hard-coded or run-time parameters. For example, certain guest OSs may be assigned to use emulated floating-point operations during recurring time intervals. Alternatively or additionally, the hypervisor may assign operations based on input from a user.

As used herein, the term “processor” includes, but is not limited to, a general purpose processor, a special purpose processor, a conventional processor, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine. A processor may have single or multiple cores. A processor may be a 4-, 8-, 6-, 32-, 64-, or 128-bit processor.

As used herein, the term “circuit” includes any single electronic component of combination of electronic components, either active and/or passive, that are coupled together to perform one or more functions. A circuit may be composed of components such as, for example, resistors, capacitors, inductors, memristors, diodes, or transistors. Examples of circuits include but are not limited to a microcontroller, a processor, an ALU, an FPU, and a GPU.

As used herein, the term “computer-readable medium” includes, but is not limited to, a cache memory, a read-only memory (ROM), a semiconductor memory device such as a D-RAM, S-RAM, or other RAM, a magnetic medium such as a flash memory, a hard disk, a magneto-optical medium, an optical medium such as a CD-ROM, a digital versatile disk (DVD), or Blu-Ray disc (BD), other volatile or non-volatile memory, or any electronic data storage device.

As used herein, the terms “software module” and “firmware module” include, but are not limited to, an executable program, a function, a method call, a procedure, a routine or sub-routine, an object, a data structure, or one or more executable instructions. A “software module” or a “firmware module” may be stored in one or more computer-readable media.

Although features and elements are described above in particular combinations, each feature or element may be used alone without the other features and elements or in various combinations with or without other features and elements. The sub-elements of the methods and features as described above may be realized in any order (including concurrently), in any combination or sub-combination. Sub-elements described with reference to any single Figure may be used in combination with the sub-elements described with reference to any other Figure or combination of other Figures.

What is claimed is:

1. A method for use in a processor, the method comprising:
using a first circuit to perform operations of a first type;
using a second circuit to perform operations of a second type;
based on a number of operations of the first type in a set of instructions, switching to using the second circuit to perform operations of the first type; and
reducing power to the first circuit.

2. The method of claim 1, wherein the first circuit is a Floating Point Unit (FPU), the operations of the first type are floating-point operations, the second circuit is an Arithmetic Logic Unit (ALU), and the operations of the second type are integer operations.

3. The method of claim 1, wherein the using the second circuit to perform operations of the first type comprises:
an emulation unit emulating operations of the first type.

4. The method of claim 3, wherein the switching to using the second circuit to perform operations of the first type includes loading state data from the first circuit into the emulation unit.

5. The method of claim 3, wherein the emulation unit emulating operations of the first type includes invoking a software module or directly invoking microcode instructions.

6. The method of claim 1, wherein the switching to using the second circuit to perform operations of the first type is further based on a number of operations of the second type in the set of instructions.

7. The method of claim 1, wherein the reducing power to the first circuit includes power gating the first circuit or clock gating the first circuit.

8. A processor, comprising:
a first circuit configured to perform operations of a first type;
a second circuit configured to perform operations of a second type;
a switching control unit configured to switch the processor to use the second circuit to perform operations of the first type based on a number of operations of the first type in a set of instructions; and
a power adjustment unit configured to reduce power to the first circuit in response to the switch to use the second circuit to perform operations of the first type.

9. The processor of claim 8, wherein the first circuit is a Floating Point Unit (FPU), the operations of the first type are floating-point operations, the second circuit is an Arithmetic Logic Unit (ALU), and the operations of the second type are integer operations.

10. The processor of claim 8, further comprising:
an emulation unit configured to emulate, in conjunction with the second circuit, operations of the first type.

11. The processor of claim 10 further comprising:
a state transfer unit configured to load state data from the first circuit into the emulation unit in response to switching the processor to use the second circuit to perform operations of the first type.

12. The processor of claim 10, wherein the emulation unit is configured to emulate operations of the first type by invoking a software module or directly invoking microcode instructions.

13. The processor of claim 8, wherein the switching control unit is configured to switch the processor to use the second circuit to perform operations of the first type further based on a number of operations of the second type in the set of instructions.

14. The processor of claim 13, wherein the power adjustment unit is configured to reduce power to the first circuit by power gating the first circuit or clock gating the first circuit.

15. A computer-readable medium storing a set of instructions for execution by a processor, the set of instructions comprising:
a first processing segment for performing operations of a first type with a first circuit;
a second processing segment for performing operations of a second type with a second circuit;
a switching control segment for switching the processor to use the second circuit to perform operations of the first type based on a number of operations of the first type in a set of instructions; and
a power adjustment segment for reducing power to the first circuit in response to the switch to use the second circuit to perform operations of the first type.

16. The computer-readable medium of claim 15, wherein the first circuit is a Floating Point Unit (FPU), the operations of the first type are floating-point operations, the second circuit is an Arithmetic Logic Unit (ALU), and the operations of the second type are integer operations.

17. The computer-readable medium of claim 15, further comprising:
an emulation segment for emulating operations of the first type with an emulation unit.

18. The computer-readable medium of claim 17, wherein the switching control segment includes instructions for loading state data from the first circuit into the emulation unit.

19. The computer-readable medium of claim 17, wherein the emulation segment includes instructions for invoking a software module or directly invoking microcode instructions.

20. The computer-readable medium of claim 15, wherein the power adjustment segment includes instructions for power gating the first circuit or clock gating the first circuit.
